(19) United States
(12) Patent Application Publication
(10) Pub. No.: US 2007/0035756 A1
(43) Pub. Date: Feb. 15, 2007

(54) Image forming apparatus

(75) Inventor: Kyoichi Shibata, Mishima-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/201,856

(22) Filed: Aug. 10, 2005

(51) Int. Cl. G06F 3/12

(52) U.S. Cl. 358/1.13

(57) ABSTRACT

There is disclosed an image forming apparatus that can reduce the burden of an image scanning device when executing a test proof mode, and as well as can reduce the burden of a user. The image forming apparatus according to the present invention forms images on sheets based on setup information, which includes a setup information storage unit that stores setup information including a printout number for forming images on sheets, an image forming unit that forms images on sheets, and a control unit that, after making the image forming unit perform image forming by at least one printout number based on the setup information, maintains the printout number stored in the setup information storage unit regardless of a printout number of image forming carried out by the image forming unit in case it is determined that a change is made in the setup information stored in the setup information storage unit, and makes the image forming unit perform image forming based on the setup information stored in the setup information storage unit.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### RELATED APPLICATION INFORMATION

This patent is related to , which is incorporated herein by reference.

### BACKGROUND OF THE INVENTION

1. Field of the Invention

The present invention relates to an image forming apparatus, an image forming method, and an image forming program that can form images on sheets based on setup information specified by a user using, for example, an MFP (Multi Function Peripheral).

2. Description of the Related Art

Conventionally, an MFP having an image forming apparatus can realize various functions, while the operation of which is becoming complicated. Accordingly, images formed by a user sometimes do not fulfill the intention of the user who sets up the images due to setup miss or operation error of the user.

Accordingly, there is employed a procedure in which a test mode function that judges the right and wrong of image forming based on setup information is used, and final printout processing is carried out after the user confirms that there is no need of modification.

However, in the conventional method, there are raised the following problems.
(1) When forming images on sheets by a setup printout number after judging the right and wrong of setup information under the test mode, it is necessary to scan original image data using an image scanning device once again. Accordingly, the image scanning device is used again so as to form image data that is completely identical with that actually formed under the test mode, which raises a problem of consequently bringing forward the wastage of the image scanning device and its accompanying items (gum and roller).
(2) When the user changes the setup after performing image forming on at least one sheet, the printout number has to be set up again.

Furthermore, in case the setup printout number is originally one, the user is required to judge whether or not an image formed on a sheet under the test mode is considered to be of the final printout processing, or the setup should be changed to carry out image forming under the test mode again. In this case, the procedure by the user comes to be different depending on the setup printout number or whether or not the setup is changed, which raises a problem of making the operation procedure troublesome and complicated.

It is therefore an object of the present invention to overcome the above-mentioned drawbacks by providing an image forming apparatus, an image forming method, and an image forming program that can reduce the wastage of the image scanning device and its roller etc., simplify the operation procedure to remove troublesome and complicated works, and reduce the burden of the user.

### DESCRIPTION OF THE DRAWINGS

FIG. 1 shows a block diagram indicative of the fundamental configuration in the embodiment according to the present invention.

FIG. 2 shows a flowchart indicative of the processing in the embodiment.

### DETAILED DESCRIPTION OF THE INVENTION

The present invention will further be described below with reference to the accompanying drawings.

Throughout this description, the embodiments and examples shown should be considered as exemplars, rather than limitations on the apparatus, methods and programs of the present invention.

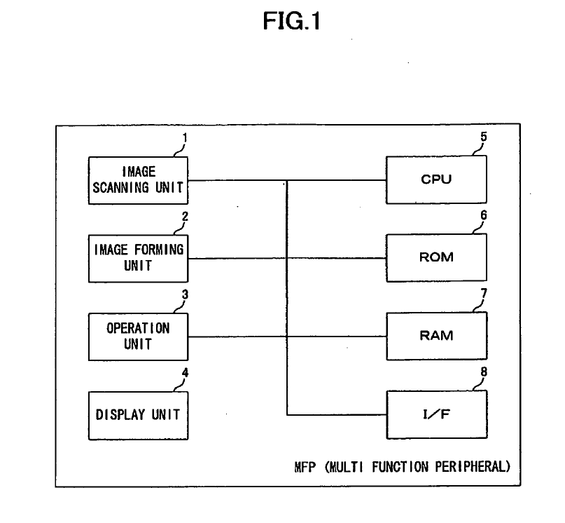

FIG. 1 shows a block diagram indicative of the configuration of an MFP (Multi Function Peripheral) in the embodiment according to the present invention.

The MFP shown in FIG. 1 includes an image scanning unit 1, an image forming unit 2, an operation unit 3, a display unit 4, a CPU 5, a ROM 6, a RAM 7, and an interface 8. The image scanning unit 1 has a scanner, not shown, and scans drafts of sheets (for example, papers) to generate electronic data of thus scanned drafts, thereby obtaining image data. The image forming unit 2 converts the image data to that of bitmap format based on setup information such as shrinking/expanding, gutter, shading of printout, and prints out thus converted image data on sheets. The operation unit 3 works cooperatively with the display unit 4, and configures a user touch panel or the like to accept operation of a user to receive setup information etc. The display unit 4 can display the operation method, received setup information, etc. The setup information means a printout number, shrinking/expanding, printout shading, gutter, etc., and the image forming unit 2 forms images on sheets based on the setup information using image data scanned by the image scanning unit (scanner) 1.

The CPU 5 is provided with a function of performing various processing in the MFP. Furthermore, the CPU 5 realizes various workings by executing programs stored in memories such as the ROM 6 and RAM 7. The ROM 6 and RAM 7 store various items of information and programs to be utilized in the MFP. The interface 8 transmits and receives information with external devices. The CPU 5 configures a control unit in the present invention.

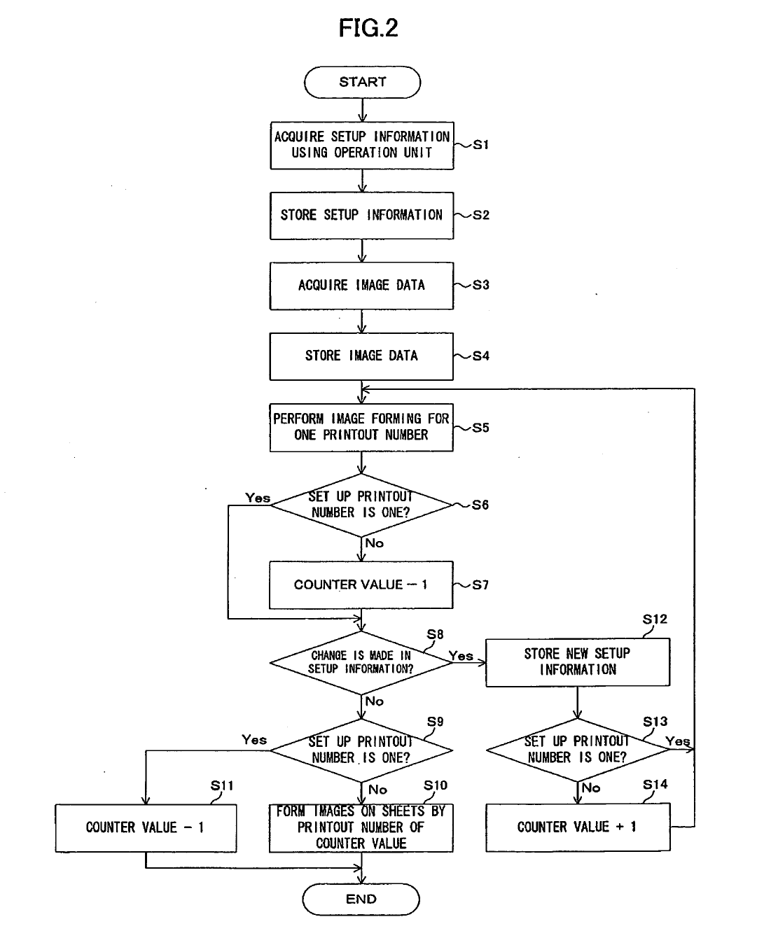

Next, the performance of a test mode in the embodiment according to the present invention will be explained with reference to a flowchart shown in FIG. 2. The test mode is a function of an image forming apparatus which forms images on sheets based on setup information set up by a user, and makes the user judge the right and wrong of the result of image forming.

Firstly, parameters of a printout number, shrinking/expanding, or the like to be used at the time of forming images on sheets are acquired based on the operation of the operation unit 3 by the user (step S1), and then thus acquired parameters are stored in a setup information storage unit configured by the RAM 7 and the like. (step S2).

Next, drafts are scanned by the image scanning unit 1 (step S3), and thus scanned image data is stored in an image data storage unit configured by the RAM 7 and the like. (step S4), and image forming for one printout number is performed on a sheet (step S5). At this time, the user can confirm whether or not the setup information fulfills the intention of the user by taking a look at the printout result. When the user desires to change the setup information after looking at the printout result, the user can re-input or input again new setup information using the operation unit 3. Due to the re-input operation, it is determined that a change is made in step S8 to be described later.

Then, among the setup information, it is judged whether or not the printout number set up by the user is one (step S6), and in case the setup printout number is other than one, one is subtracted from the counter value of a counter that counts the setup printout number (step S7).

Then, it is detected whether or not operation of re-inputting setup information is carried out using the operation unit 3, and it is judged whether or not a change is made under the condition that re-inputting operation is performed (step S8).

When a change is not made, the setup printout number is judged (step S9), and in case the setup printout number is other than one (step S9, No), images are formed on sheets by the counter value of the counter using the image data stored in step S4 (step S10). In case the setup printout number is one (step S9, Yes), one is subtracted from the counter value (step S11), and the processing is ended. In this processing, since image data that is previously stored in step S4 is used, it is not necessary to use the image scanning unit 1 so as to acquire image data that is identical with the stored data. Accordingly, it becomes possible to reduce burden on the image scanning device and its accompanying items (gum and roller). Furthermore, managing the printout processing with the counter value including the printout number for the test mode, printout processing is performed by the initially set up printout number, which can cut out useless printout processing.

In case it is determined that a change is made in the setup information (step S8, Yes), new setup information is stored in the setup information storage unit (step S12).

Then, it is judged whether or not the set up printout number is one (step S13), and in case the setup printout number is other than one (step S13, No), one is added to the counter value (step S14), returning to step S5 to form an image on a sheet for judging the right and wrong of the changed setup information. In case the setup printout number is one (step S13, Yes), the count value is not returned, returning to step S5.

In the above-described embodiment, the user actually takes a look at the image forming result under the test mode for changing the setup information, and can change the setup information as many times as the user wants until image forming fulfilling the intention of the user is carried out. In this case, image forming under the test mode is automatically performed when the user carries out a simple procedure of changing the setup information. Furthermore, in case the printout result fulfills the intention of the user, the printout number is adjusted. Accordingly, burden of the user can be reduced. Furthermore, image data stored under the test mode is used consistently, which can reduce the scanning performance time by the image scanning unit 1 to one.

The respective steps in the processing of above-described image forming apparatus is realized when making the CPU 5 execute image forming programs stored in the memory such as the ROM 6 and RAM 7.

Although shown implemented in a personal computer, the invention may be implemented with any computing device. A computing device as used herein refers to any device with a processor, memory and a storage device that may execute instructions including, but not limited to, personal computers, server computers, computing tablets, set top boxes, video game systems, personal video recorders, telephones, personal digital assistants (PDAs), portable computers, and laptop computers. These computing devices may run any operating system, including, for example, variations of the Linux, Unix, MS-DOS, Microsoft Windows, Palm OS, and Apple Mac OS X operating systems.

Although the techniques discussed herein are described with regard to a compact disk, the techniques may be implemented with any storage media in any storage device included with or otherwise coupled or attached to a computing device. These storage media include, for example, magnetic media such as hard disks, floppy disks and tape; optical media such as compact disks (CD-ROM and CD-RW) and digital versatile disks (DVD and DVD±RW); flash memory cards; and any other storage media. As used herein, a storage device is a device that allows for reading and/or writing to a storage medium. Storage devices include, hard disk drives, DVD drives, flash memory devices, and others.

By data unit, it is meant a frame, cell, datagram, packet or other unit of information.

While the present invention has been described in accordance with certain preferred embodiments thereof, it should be understood by those ordinarily skilled in the art that the invention is not limited to the embodiments, but various modifications, alternative constructions or equivalents can be implemented without departing from the scope and spirit of the present invention.

1. An image forming apparatus which forms images on sheets based on setup information, comprising:
a setup information storage unit which stores setup information including a printout number for forming images on sheets;
an image forming unit which forms images on sheets; and
a control unit which, after making the image forming unit perform image forming by at least one printout number based on the setup information, maintains the printout number stored in the setup information storage unit regardless of a printout number of image forming carried out by the image forming unit in case it is determined that a change is made in the setup information stored in the setup information storage unit, and makes the image forming unit perform image forming based on the setup information stored in the setup information storage unit.

2. The image forming apparatus according to claim 1, further comprising:
an image scanning unit which scans image data; and
an image data storage unit which stores image data scanned by the image scanning unit, wherein
the image forming unit forms images by the printout number stored in the setup information storage unit using image data stored in the image data storage unit based on an instruction from the control unit.

3. The image forming apparatus according to claim 1, wherein
a proof mode for judging the right and wrong of image forming based on the setup information, and
in case the proof mode is executed, after making the image forming unit perform image forming by at least one printout number based on the setup information, the control unit maintains the printout number stored in the setup information storage unit regardless of a printout number of image forming carried out by the image forming unit in case it is determined that a change is made in the setup information stored in the setup information storage unit, and makes the image forming unit perform image forming based on the setup information stored in the setup information storage unit.

4. The image forming apparatus according to claim 1, wherein,
in case it is determined that a change is not made in the setup information stored in the setup information storage unit, the control unit subtracts a printout number of image forming carried out by the image forming unit from the printout number stored in the setup information storage unit, and updates the printout number stored in the setup information storage unit to a resulting printout number from which the printout number of image forming carried out by the image forming unit is subtracted so as to make the image forming unit form images.

5. The image forming apparatus according to claim 4, wherein
the control unit makes the image forming unit form images consecutively by the updated printout number.

6. The image forming apparatus according to claim 4, wherein
the determination that a change is not made in the setup information is performed based on an input instruction.

7. An image forming method which forms images on sheets based on setup information, comprising:
a setup information storage step which stores setup information including a printout number for forming images on sheets;
an image forming step which performs image forming by at least one printout number based on the setup information stored in the setup information storage step;
a judgment step which judges whether or not a change is made in the setup information stored in the setup information storage step; and
a repetition step which maintains the printout number stored in the setup information storage step regardless of a printout number of image forming carried out in the image forming step in case it is determined that a change is made in the setup information in the judgment step, and repeats the image forming step.

8. The image forming method according to claim 7, further comprising:
an image scanning step which scans image data; and
an image data storage step which stores image data scanned in the image scanning step,
wherein the repetition step forms images using image data stored in the image data storage step.

9. The image forming method according to claim 7, further comprising:
a proof mode setup step which sets up a proof mode which judges the right and wrong of image forming based on the setup information, wherein
the judgment step and the repetition step are carried out in case the proof mode is executed.

10. The image forming method according to claim 7, further comprising:
an update step which, in case it is determined that a change is not made in the setup information in the judgment step, subtracts a printout number of image forming carried out in the image forming step from the printout number stored in the setup information storage step, and updates the printout number stored in the setup information storage step to a resulting printout number from which the printout number of image forming carried out in the image forming step is subtracted.

11. The image forming method according to claim 10, further comprising:
a consecutive image forming step which forms images consecutively by the updated printout number.

12. An image forming program which makes a computer execute an image forming method which forms images on sheets based on setup information, the program making the computer execute the steps of:
a setup information storage step which stores setup information including a printout number for forming images on sheets;
an image forming step which performs image forming by at least one printout number based on the setup information;
a judgment step which judges whether or not a change is made in the setup information stored in the setup information storage step; and
a repetition step which maintains the printout number stored in the setup information storage step regardless of a printout number of image forming carried out in the image forming step in case it is determined that a change is made in the setup information in the judgment step, and repeats the image forming step.

13. The image forming program according to claim 12, further comprising:
an image scanning step which scans image data; and
an image data storage step which stores image data scanned in the image scanning step,
wherein the repetition step forms images using image data stored in the image data storage step.

14. The image forming program according to claim 12, further comprising:
a proof mode setup step which sets up a proof mode which judges the right and wrong of image forming based on the setup information, wherein
the judgment step and the repetition step are carried out in case the proof mode is executed.

15. The image forming program according to claim 12, wherein,
in the judgment step, in case it is determined that a change is not made in the setup information stored in the setup information storage step, a printout number of image forming carried out in the image forming step is subtracted from the printout number stored in the setup information storage step, and the printout number stored in the setup information storage step is updated to a resulting printout number from which the printout number of image forming carried out in the image forming step is subtracted so as to form images in the image forming step.

16. The image forming program according to claim 15, further comprising:
a consecutive image forming step which forms images consecutively by the updated printout number.
